(19) United States
(12) Patent Application Publication
(10) Pub. No.: US 2026/0206092 A1
(43) Pub. Date: Jul. 16, 2026

(54) VOICE OVER INTERNET PROTOCOL (VOIP) AUDIO PROCESSING

(71) Applicant: QUALCOMM Incorporated, San Diego, CA (US)

(72) Inventors: Prasad Prakash NETALKAR, San Diego, CA (US); Leena ZACHARIAS, San Jose, CA (US); Arnaud MEYLAN, San Diego, CA (US); Pradeep GANAPATHY, San Diego, CA (US); Akshay KUMAR, San Diego, CA (US)

(21) Appl. No.: 19/023,091

(22) Filed: Jan. 15, 2025

(51) Int. Cl. H04W 76/28; H04M 7/00; H04W 52/02

(52) U.S. Cl. CPC H04W 76/28; H04M 7/006; H04W 52/0216

(57) ABSTRACT

A method of wireless communication includes performing audio processing to encode audio packets for voice over internet protocol (VoIP) communications during connected mode discontinuous reception (CDRX) operation. The audio processing occurs after an end of a prior ON duration of a prior CDRX cycle and either during a previous modem ramp-down period or during a current modem ramp up period. The ramp down period and the ramp up period correspond to a sleep time of a modem in the CDRX cycle. The method also includes transmitting the audio packets during a current CDRX cycle that follows the prior ON duration of the prior CDRX cycle.

### FIELD OF THE DISCLOSURE

The present disclosure relates generally to wireless communications, and more specifically to a voice over internet protocol (VoIP) audio processing timeline during connected discontinuous reception (CDRX) operation.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method for wireless communication includes performing audio processing to encode audio packets for voice over internet protocol (VoIP) communications during connected mode discontinuous reception (CDRX) operation. The audio processing occurs after an end of a prior ON duration of a prior CDRX cycle and either during a previous modem ramp-down period or during a current modem ramp up period. The ramp down period and the ramp up period correspond to a sleep time of a modem in the CDRX cycle. The method also includes transmitting the audio packets during a current CDRX cycle that follows the prior ON duration of the prior CDRX cycle.

Other aspects of the present disclosure are directed to an apparatus. The apparatus has one or more memories and one or more processors coupled to the one or more memories. The processor(s) is configured to perform audio processing to encode audio packets for voice over internet protocol (VoIP) communications during connected mode discontinuous reception (CDRX) operation. The audio processing occurs after an end of a prior ON duration of a prior CDRX cycle and either during a previous modem ramp-down period or during a current modem ramp up period. The ramp down period and the ramp up period correspond to a sleep time of a modem in the CDRX cycle. The processor(s) is also configured to transmit the audio packets during a current CDRX cycle that follows the prior ON duration of the prior CDRX cycle.

In other aspects of the present disclosure, a non-transitory computer-readable medium with program code recorded thereon is disclosed. The program code is executed by a processor and includes program code to perform audio processing to encode audio packets for voice over internet protocol (VoIP) communications during connected mode discontinuous reception (CDRX) operation. The audio processing occurs after an end of a prior ON duration of a prior CDRX cycle and either during a previous modem ramp-down period or during a current modem ramp up period. The ramp down period and the ramp up period correspond to a sleep time of a modem in the CDRX cycle. The program code also includes program code to transmit the audio packets during a current CDRX cycle that follows the prior ON duration of the prior CDRX cycle.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a timeline illustrating current audio processing for voice over internet protocol (VoIP) communications in a connected discontinuous reception (CDRX) mode with a scheduling request (SR) inside.

FIG. 5 is a timeline illustrating current audio processing for voice over internet protocol (VoIP) communications in a connected discontinuous reception (CDRX) mode with a scheduling request (SR) ahead.

FIG. 6 is a table illustrating actions for different IP multimedia subsystem (IMS) state combinations during voice over internet protocol (VoIP) communications in a connected discontinuous reception (CDRX) mode, in accordance with various aspects of the present disclosure.

FIG. 7 is a timeline illustrating audio processing for voice over internet protocol (VoIP) communications in a connected discontinuous reception (CDRX) mode with a scheduling request (SR) ahead and in a TALK state, in accordance with various aspects of the present disclosure.

FIG. 8 is a timeline illustrating audio processing for voice over internet protocol (VoIP) communications in a connected discontinuous reception (CDRX) mode with a scheduling request (SR) inside and in a TALK state, in accordance with various aspects of the present disclosure.

FIG. 9 is a timeline illustrating audio processing for voice over internet protocol (VoIP) communications in a connected discontinuous reception (CDRX) mode with a scheduling request (SR) ahead and in a SILENCE to TALK state transition, in accordance with various aspects of the present disclosure.

FIG. 10 is a timeline illustrating audio processing for voice over internet protocol (VoIP) communications in a connected discontinuous reception (CDRX) mode with a scheduling request (SR) inside and in a SILENCE to TALK state transition, in accordance with various aspects of the present disclosure.

FIG. 11 is a timeline illustrating audio processing for voice over internet protocol (VoIP) communications in a connected discontinuous reception (CDRX) mode with a scheduling request (SR) ahead and audio processing in a later CDRX cycle, in accordance with various aspects of the present disclosure.

FIG. 12 is a flow diagram illustrating an example process performed, for example, by a user equipment (UE), in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Voice over internet protocol (VoIP) communication involves interactions between a modem and an audio processor, such as an audio digital signal processor (ADSP). The ADSP may generate audio packets for the modem to transmit. An IP multimedia subsystem (IMS) may pick up processed audio packets and deliver the packets to the media access control (MAC) layer for over the air (OTA) transmission.

Connected mode discontinuous reception (CDRX) is an energy savings mode for wireless communications where a user equipment (UE) periodically enters a sleep state. During each CDRX cycle, the UE awakens from the sleep state and enters a wake state (e.g., ON duration) to transmit and receive data before returning to the sleep state to save battery power.

For uplink VoIP communications while the UE is in a CDRX mode, the IMS aligns audio real-time transport protocol (RTP) packet generation to the CDRX schedule and to any scheduling requests (SRs) in order to improve power consumption. More specifically, the IMS attempts to limit audio processing to when the modem is awake in a CDRX cycle. By controlling the audio processing in this manner, the time when the system-on-a-chip (SOC) can be in low power mode is increased.

In current systems, a decision to program a modem to wake up before an SR occurs before the end of a CDRX ON duration, which limits the opportunity to perform audio encoding or processing before an end of ON duration time for determining whether a currently unknown TALK or SILENCE state exists in order to program a next CDRX cycle. As a result, end-to-end latency is increased.

According to aspects of the present disclosure, a modem is programmed to awaken based on a previous TALK or SILENCE state at the end of an ON duration in a previous cycle. When in a TALK state, wake-up is programmed based on the assumption that there will be a TALK state in the next CDRX cycle. When transitioning from a SILENCE state to a TALK state, a rude wake-up is performed in order to be ready for the next SR. A rude wake-up is based on an interrupt, without prior programming in the previous cycle. According to further aspects of the present disclosure, when in a SILENCE state, a wake-up is not programmed, based on an assumption that there will be SILENCE in the next cycle. The modem will awaken for an ON duration but not for an SR.

Particular aspects of the subject matter described in this disclosure can be implemented to realize one or more of the following potential advantages. In some examples, the described techniques, such as performing audio encoding or processing towards the end of the modem ramp-down period may reduce end-to-end latency. Moreover, a viable power-to-latency trade-off is obtained by delaying encoding as late as possible instead of always encoding in the previous cycle, thus reducing overall end-to-end latency. If encoding can occur in a same cycle as a physical uplink shared channel (PUSCH) transmission, further latency savings are achieved. The lower latency improves performance of VoIP calls.

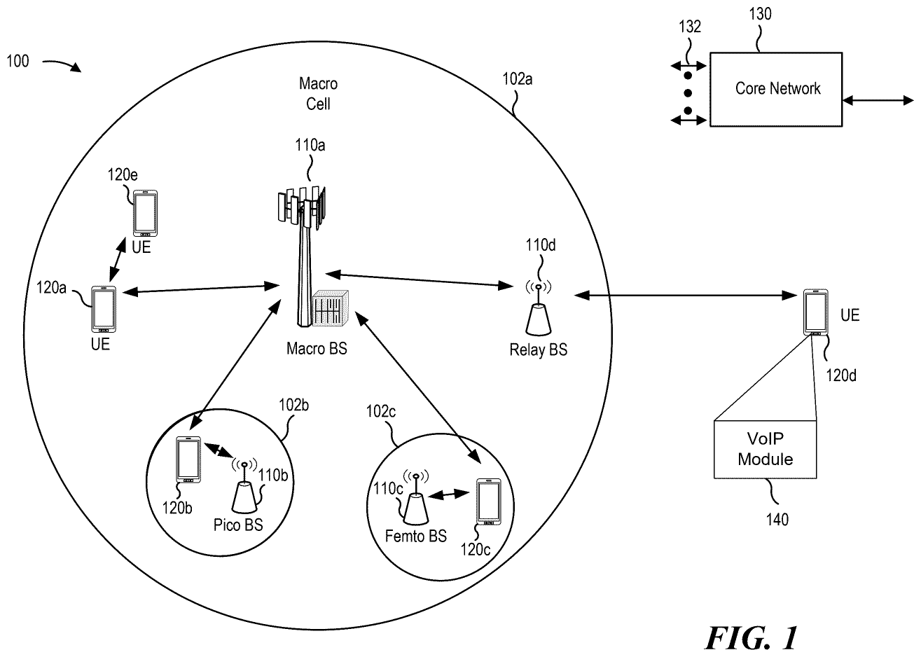

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real-time (near-RT) RAN intelligent controller (RIC), or a non-real-time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a voice over internet protocol (VoIP) module 140. For brevity, only one UE 120d is shown as including the VoIP module 140. The VoIP module 140 may perform audio processing to encode audio packets for voice over internet protocol (VoIP) communications during connected mode discontinuous reception (CDRX) operation. The audio processing occurs after an end of a prior ON duration of a prior CDRX cycle and either during a previous modem ramp-down period or during a current modem ramp up period. The ramp down period and the ramp up period correspond to a sleep time of a modem in the CDRX cycle. The VoIP module 140 may transmit the audio packets during a current CDRX cycle that follows the prior ON duration of the prior CDRX cycle.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

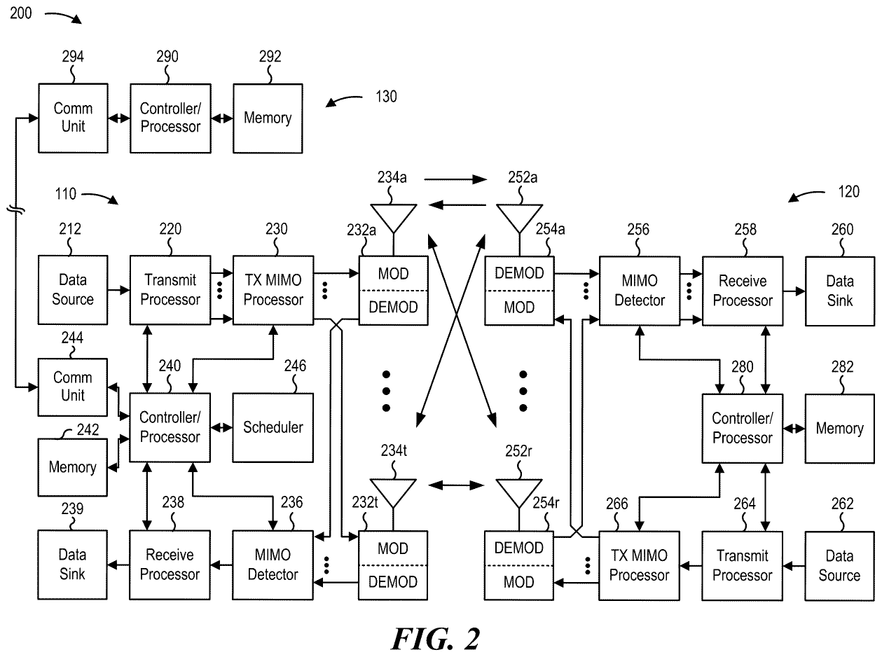

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

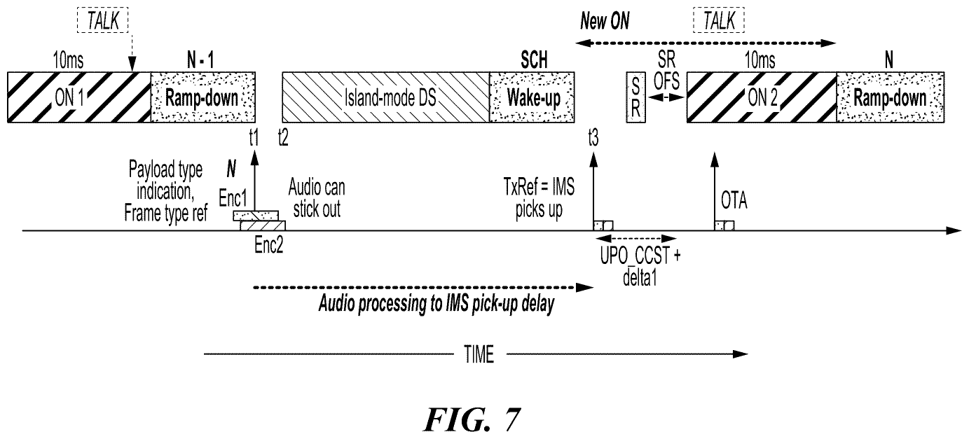

The controller/processor 240 of the base station 110, the controller/processor 280 of the UE 120, and/or any other component(s) of FIG. 2 may perform one or more techniques associated with delayed audio processing for VoIP communications, as described in more detail elsewhere. For example, the controller/processor 280 of the UE 120, and/or any other component(s) of FIG. 2 may perform or direct operations of, for example, the processes of FIGS. 7-13 and/or other processes as described. Memories 242 and 282 may store data and program codes for the base station 110 and UE 120, respectively. A scheduler 246 may schedule UEs for data transmission on the downlink and/or uplink.

In some aspects, the UE 120 may include means for receiving, means for transmitting, means for programming, means for completing, and means for starting. Such means may include one or more components of the UE 120 described in connection with FIG. 2, such as the controller/processor 280, the memory 282, the transmit processor 264, the TX MIMO processor 266, the modulator 254, and/or the antenna 252.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

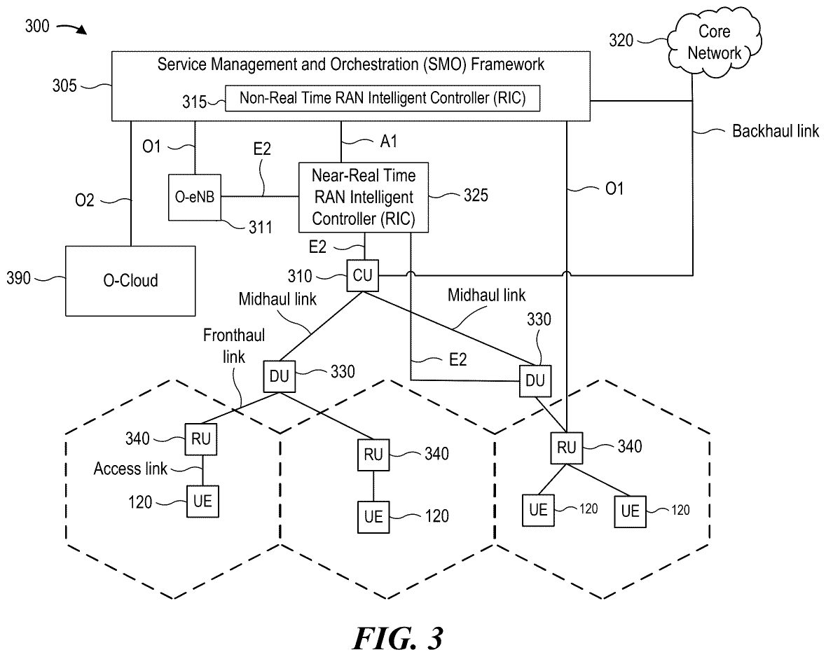

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real-time (near-RT) RAN intelligent controller (RIC) 325 via an E2 link, or a non-real-time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation, and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

Voice over internet protocol (VoIP) communication involves interactions between a modem and an audio processor, such as an audio digital signal processor (ADSP). The ADSP may generate audio packets for the modem to transmit. An IP multimedia subsystem (IMS) may pick up processed audio packets and deliver the packets to the media access control (MAC) layer for over the air (OTA) transmission.

Connected mode discontinuous reception (CDRX) is an energy savings mode for wireless communications where a UE periodically enters a sleep state. During each CDRX cycle, the UE awakens from the sleep state and enters a wake state (e.g., ON duration) to transmit and receive data before returning to the sleep state to save battery power.

For uplink VoIP communications while the UE is in a CDRX mode, the IMS aligns audio real-time transport protocol (RTP) packet generation to the CDRX schedule and to any scheduling requests (SRs) in order to improve power consumption. More specifically, the IMS attempts to limit audio processing to when the modem is awake in a CDRX cycle. By controlling the audio processing in this manner, the time when the system-on-a-chip (SOC) can be in low power mode is increased.

The uplink (UL) packet offset with respect to the next CDRX cycle start time (UPO_CCST) is configured to meet the following two conditions: the UL packet(s) reaches the media access control (MAC) layer exactly on time to trigger the SR transmission, and the UL packet(s) reaches the MAC layer before the next CDRX cycle starts.

The calculation of UPO_CCST takes the following into consideration: the selected SR occasion with respect to the next CDRX cycle start time; the modem UL processing time (MPT_UL); the IMS_MAC_delay, which is the maximum time measured from the “IMS delivering the RTP to the data service” to “the MAC ready for SR trigger to the grant manager,” which may be one millisecond (1 ms) in some implementations. ; the MAC_SR_delay, which is the maximum time measured from “the MAC triggering an SR to GM” to “a physical uplink control channel (PUCCH)-SR occasion.” The MAC_SR_delay should be set to one slot for operations in sub-6 gigahertz (GHz) systems; and UPO_CCST=Max(MPT_UL (e.g., two ms), IMS_MAC_delay+MAC_SR_delay+SR_OFS.

The decision to program a scheduled wake-up before an SR for a next cycle should come at the end of an ON duration in a previous CDRX cycle. The modem always wakes up for the ON duration, and if the SR occurs ahead of the ON duration, the modem wakes up before the SR when there are data packets to send.

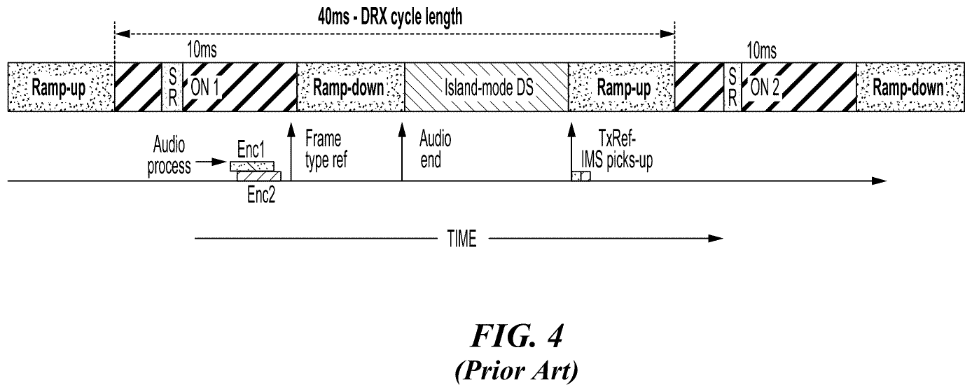

FIG. 4 is a timeline illustrating current audio processing for voice over internet protocol (VoIP) communications in a connected discontinuous reception (CDRX) mode with a scheduling request (SR) inside an ON duration. As seen in FIG. 4, an IP multimedia subsystem (IMS) provides the following reference timestamps to an audio digital signal processor (ADSP) to align audio packet capture and transmission encoding with the modem. The frame type reference (ref) represents a time by which the audio processor will make its best efforts to indicate whether audio will be present in the next cycle for a scheduled wake-up. The equation for determining when the frame type reference occurs is: CDRX start+ON duration−delta3−CDRX cycle length (end of ON duration in the previous cycle), where delta3 is the margin for the IMS providing a DATA/NO-DATA indication to the MAC layer, with a default value of 1 ms. In the example of FIG. 4, the frame type ref occurs at the end of an ON duration ON 1 in the current CDRX cycle. The ramp-up period is a time for the modem to complete its ramp-up, for example, if modem needs to be awake at the start of the ON duration, then the value indicates the gap between a ramp-up start instance and an ON duration start time.

In the example of FIG. 4, the scheduling requests (SRs) occur within the ON durations ON 1 and ON 2. After the ON duration of the current cycle ON 1, a ramp-down period occurs. The ramp-down period is the time required for the modem to start scheduling the sleep operation. During the ON duration of the current cycle ON 1, the audio processor encodes two audio packets Enc1, Enc2, which may each have a length of 20 ms, in an implementation where the CDRX cycle length is 40 ms. The two audio packets encoding 1 (Enc1), encoding 2 (Enc2) are processed before the end of the CDRX ON duration of the current cycle ON 1. The audio processor provides the information to the IMS, which then provides information to the MAC layer at the modem to schedule wake-up.

The audio end time of the current CDRX cycle (Audio end) is a time by which the audio should stop running the processor and is equal to CDRX start+ON duration+ramp-down−CDRX cycle length (e.g., end of ramp-down/modem sleep start time in the previous cycle). After the ramp-down period, an island mode for deep sleep (DS) occurs where the audio processor and the modem are both off.

After the deep sleep ends, a TxRef occurs. The TxRef is a timestamp for when the IMS picks up the audio packet from shared memory. The worst case scenario for encoding should be completed by this time. If the SR is before the ON duration in the next cycle ON 2, then the TxRef occurs at CDRX start−UPO_CCST−delta1 (where IMS picks up the data at the CDRX cycle start time (UPO_CCST) in the current cycle), where delta1 is a margin for extra processing overhead not captured in the UPO_CCST value and may have a default value of two ms. If the SR is within or inside the ON duration in the next cycle ON 2, then the TxRef occurs at CDRX start−ramp up (when IMS picks up the data at the start of ramp up in the current cycle).

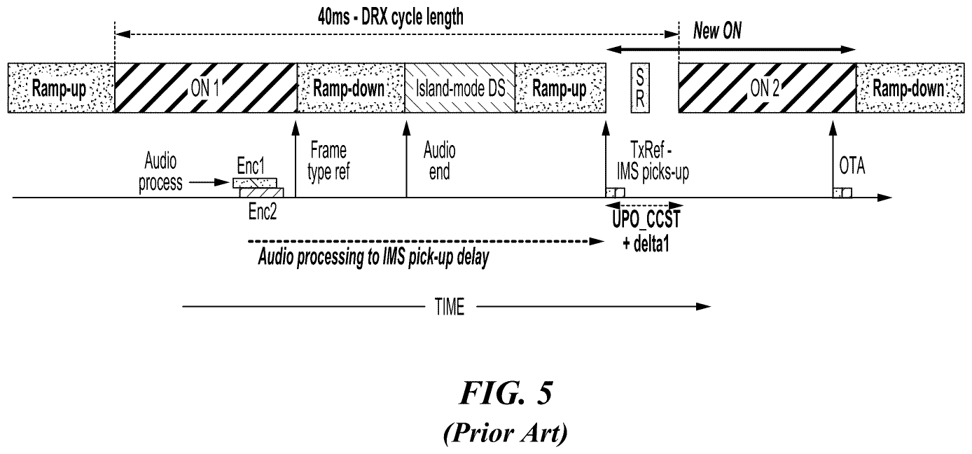

In this current design, the IMS or audio design is such that encoded packets sit in the audio buffer for 20 ms to 30 ms before the physical uplink shared channel (PUSCH) transmission (also referred to as the over the air transmission (OTA)) because encoding occurred in the prior cycle. FIG. 5 is a timeline illustrating current audio processing for voice over internet protocol (VoIP) communications in a connected discontinuous reception (CDRX) mode with a scheduling request (SR) ahead. The example of FIG. 5 is similar to the example of FIG. 4, except that the SR is before the ON duration ON 2. Thus, the TxRef occurs before the SR after the ramp-up period.

In the scenarios shown in FIGS. 4 and 5, the decision to program a modem to wake up before the SR occurs before the end of the CDRX ON duration, which limits the opportunity to perform audio encoding or processing before the frame type reference for determining whether a TALK or SILENCE state exists in order to program the next CDRX cycle. As a result, end-to-end latency is increased.

According to aspects of the present disclosure, a modem is programmed to awaken based on a previous TALK or SILENCE state at the end of an ON duration in a previous cycle. When in a TALK state, wake-up is programmed based on the assumption that there will be a TALK state in the next CDRX cycle. When transitioning from a SILENCE state to a TALK state, a rude wake-up is performed in order to be ready for the next SR. A rude wake-up is an example of a wake-up that is based on an interrupt, without prior programming in the previous cycle. The rude wake-up is slower than a programmed wake-up. According to further aspects of the present disclosure, when in a SILENCE state, a wake-up is not programmed, based on the assumption that there will be SILENCE in the next cycle. The modem will awaken for an ON duration but not for an SR.

These aspects reduce end-to-end latency by performing audio encoding or processing towards the end of the modem ramp-down period. The frame type reference time stamp is postponed until the end of the ramp-down period, delaying encoding. Moreover, a viable power-to-latency trade-off is obtained by delaying encoding as late as possible instead of always encoding in the previous cycle, thus reducing overall end-to-end latency. These aspects are applicable to long term evolution (LTE), new radio (NR), and later systems with DRX on/off periods regardless of whether the SR is inside or ahead of an ON duration.

As noted, aspects of the present disclosure maintain either the TALK or SILENCE state, for previous and current CDRX cycles. The audio processor provides this information after processing.

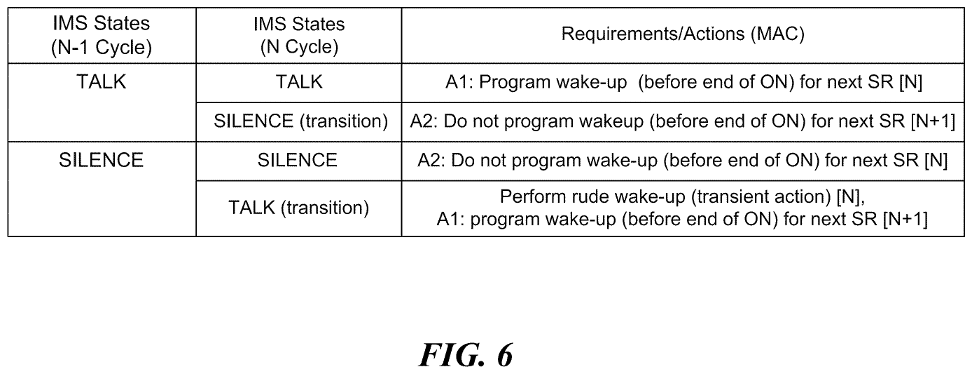

FIG. 6 is a table illustrating actions for different IMS state combinations during VoIP communications in a connected discontinuous reception (CDRX) mode, in accordance with various aspects of the present disclosure. In the example of FIG. 6, the IMS states in a previous cycle (N−1 cycle) and a current cycle (N cycle) are shown for both TALK and SILENCE states. When in a TALK state in a previous cycle and the current cycle, a wake-up is programmed before the end of the ON duration for the next SR in the current cycle (N). When in a TALK state in a previous cycle and a transition to a SILENCE state occurs for the current cycle, a wake-up is not programmed before the end of the ON duration for the next SR in the next cycle (N+1). In this scenario, a power penalty is incurred for one cycle because the modem remains awake before the SR, despite the absence of data packets to transmit.

When in a SILENCE state in a previous cycle and the current cycle, a wake-up is not programmed before the end of the ON duration for the next SR in the current cycle (N). When in a SILENCE state in a previous cycle and a transition to a TALK state occurs for the current cycle, a rude wake-up occurs for the transient action at the current cycle (N), and a wake-up is programmed before the end of the ON duration for the SR in the next cycle (N+1). In this scenario, a penalty on power is seen due to the rude wake-up for one cycle as the modem must be awake before the SR. Additionally, the audio processor interrupts the IMS when encoding is complete, hence the modem wakes-up. It is noted that if too many TALK/SILENCE state transitions occur in a call, this feature can be disabled and the UE falls back to legacy procedures.

Details of setting a timeline while operating in CDRX mode will now be described. It is assumed that a payload type is known based on the frame type reference for audio frames. It is also assumed that encoding may not be complete by the time of the frame type reference. That is, audio encoding may ‘stick out’ or continue past the transmission time for the frame type reference, for example, by one to two milliseconds (ms). As noted previously, in response to a SILENCE to TALK state transition, the UE performs a rude wake-up to be ready for the next SR based on an audio interrupt.

FIG. 7 is a timeline illustrating audio processing for voice over internet protocol (VoIP) communications in a connected discontinuous reception (CDRX) mode with a scheduling request (SR) ahead and in a TALK state, in accordance with various aspects of the present disclosure. As seen in the example of FIG. 7, a parameter frame type reference (Frame type ref) occurs at time t1 when the audio processor will try with best efforts to indicate whether there is audio in the next cycle. The time t1 is based on the equation CDRX start+ON duration+ramp-down−delta3−CDRX cycle length. The time t2 is a time by when processing of audio packets completes and is allowed extend beyond the modem ramp-down time. The audio processing can also be complete by the time t1, in which case the audio processor stop by time t1. The audio end time in the case of transmission coincides with the TxRef time at time t3. The audio should complete processing by this time if not completed in the previous cycle. An objective is to delay encoding/processing as much as possible. Because the audio processing is delayed until after the ramp-down period, the end-to-end latency is reduced.

The transmit reference (TxRef) time is a timestamp when the IMS picks up the audio packets Enc1, Enc2 from shared memory. The worst case scenario for encoding should be completed by this time, shown as time t3 in FIG. 7. In a TALK state, the TxRef time is calculated as: CDRX start−UPO_CCST−delta1+UL_slot_offset (only in TDD), where UL_slot_offset is a time between the ON duration of the current cycle ON 2 and the first time an uplink transmission has an opportunity to be sent (e.g., a transmit or shared (T/S) slot) in a time division duplex (TDD) system. In a SILENCE state, a wake-up is not programmed for an SR before the ON duration of the current cycle ON 2. For a SILENCE to TALK state transition, the audio processor interrupts the IMS software when encoding is complete such that the TxRef occurs at the frame type ref (t1)+a margin for encoding (e.g., encode_margin).

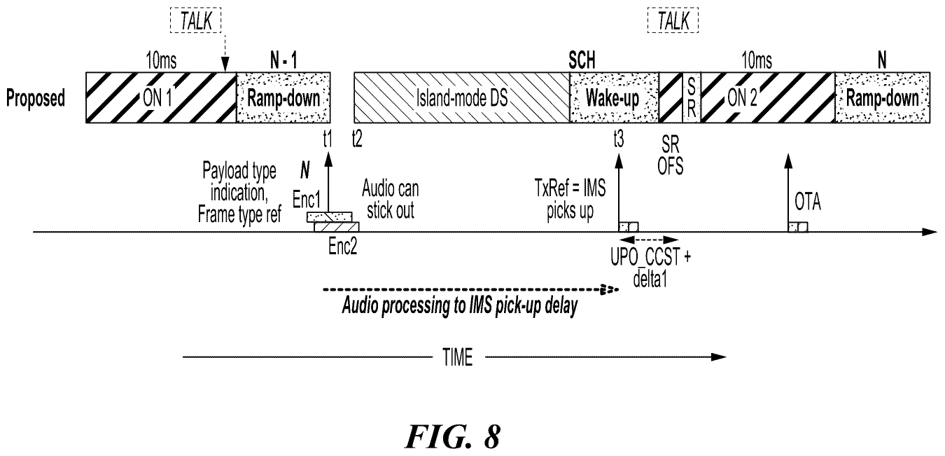

FIG. 8 is a timeline illustrating audio processing for voice over internet protocol (VoIP) communications in a connected discontinuous reception (CDRX) mode with a scheduling request (SR) inside and in a TALK state, in accordance with various aspects of the present disclosure. In the example of FIG. 8, where the SR occurs inside the ON duration for the current cycle ON 2, the TxRef occurs at the same time t3 as in the example of FIG. 7, where the SR is ahead of the ON duration ON 2. In the example of FIG. 8, the TxRef timestamp at time t3 coincides with the scheduled (SCH) wake-up period. Moreover, no programmed wake-up occurs because the modem is already scheduled to awaken for the ON duration of the current cycle ON 2.

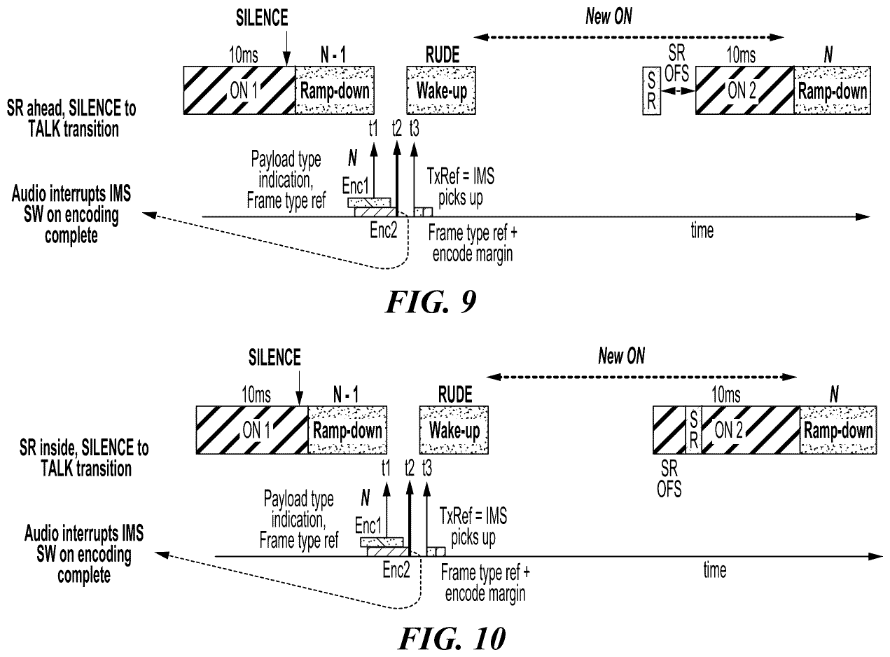

FIG. 9 is a timeline illustrating audio processing for voice over internet protocol (VoIP) communications in a connected discontinuous reception (CDRX) mode with a scheduling request (SR) ahead and in a SILENCE to TALK state transition, in accordance with various aspects of the present disclosure. FIG. 10 is a timeline illustrating audio processing for voice over internet protocol (VoIP) communications in a connected discontinuous reception (CDRX) mode with a scheduling request (SR) inside and in a SILENCE to TALK state transition, in accordance various with aspects of the present disclosure.

In the examples of FIGS. 9 and 10, the frame type ref occurs at time t1 and the audio processing ends at time t2, similar to the example discussed with respect to FIG. 7. In addition, the audio processor interrupts the IMS software (SW) when completing encoding at time t2. At time t3, the Tx Ref timestamp occurs based on the frame type ref and the encode margin. To save power, the rude wake-up or interrupt may be delayed based on the SR position and the start of the CDRX cycle. In the example of FIG. 9, the SR occurs before the ON duration of the current cycle ON 2. In the example of FIG. 10, the SR is inside the ON duration of the current cycle ON 2.

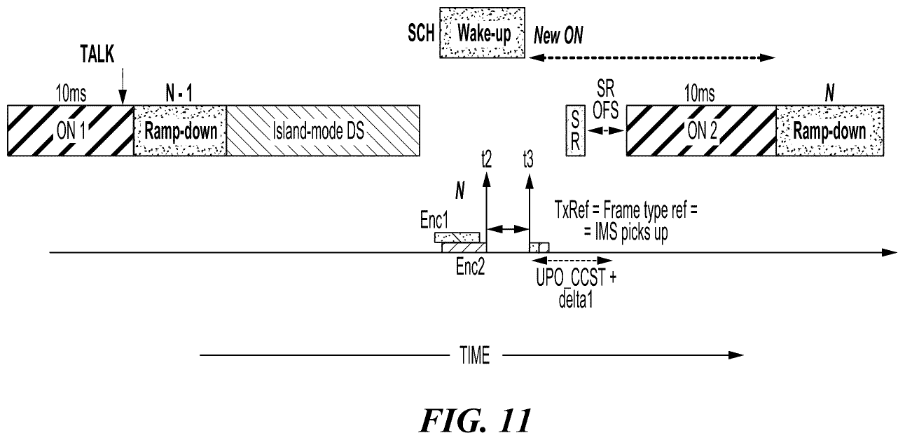

FIG. 11 is a timeline illustrating audio processing for voice over internet protocol (VoIP) communications in a connected discontinuous reception (CDRX) mode with a scheduling request (SR) ahead and audio processing in a later CDRX cycle, in accordance with various aspects of the present disclosure. The later CDRX cycle is the same cycle as a the PUSCH transmission. In these aspects, when in a TALK state, the UE determines if the audio can be processed in the same cycle as the PUSCH transmission. The determination is in accordance with the equation:

Audio out=AVG runtime audio TX delay+STD audio process margin−(Converged Wake-up−UPO_CCST−delta1+UL slot offset),

where AVG runtime audio TX delay+STD audio process margin corresponds to the amount of time needed for audio processing. Additionally, (Converged Wake-up−UPO_CCST−delta1+UL slot offset) corresponds to the time available in the ramp up period, more specifically indicating how long it takes to wake up. If the value of Audio out<an audio out threshold, then encoding may occur in the same cycle, improving latency by 20-30 ms. In the example of FIG. 11, the audio encoding ends at time t2. The TxRef occurs at time t3, which is at the same time as the frame type ref and the audio transmission end time, and is calculated as: CDRX start−UPO_CCST−delta1+UL_slot_offset.

If the audio out value is not less than the audio out threshold, then the encoding occurs in a previous cycle at the end of the ramp-down period, as seen in FIGS. 7 and 8. In this scenario, latency improves by an amount corresponding to the ramp-down period.

According to further aspects of the present disclosure, audio begins encoding in a previous cycle, interrupts, and finishes in a current cycle. Such interrupted audio processing may occur based on a processing margin in the previous CDRX cycle. Starting the encoding process in the previous cycle and completing the encoding in the current cycle allows for additional power savings. The IMS software may indicate the windows when audio processing can run, and the audio processor decides if interrupted audio processing should occur or if the audio processor can finish in a same cycle as when the PUSCH transmits.

With VoIP communications (e.g., voice over new radio (VoNR) or voice over long-term evolution (VoLTE) calls), the lower latency improves the performance of the call. By delaying encoding and shifting the timeline to the right by a duration corresponding to the end of the ramp-down period, the gain is approximately equal to the ramp-down duration. If encoding can occur in a same cycle as the PUSCH, further latency savings are achieved, e.g., up to 20-30 ms.

As indicated above, FIGS. 4-11 are provided as examples. Other examples may differ from what is described with respect to FIGS. 4-11.

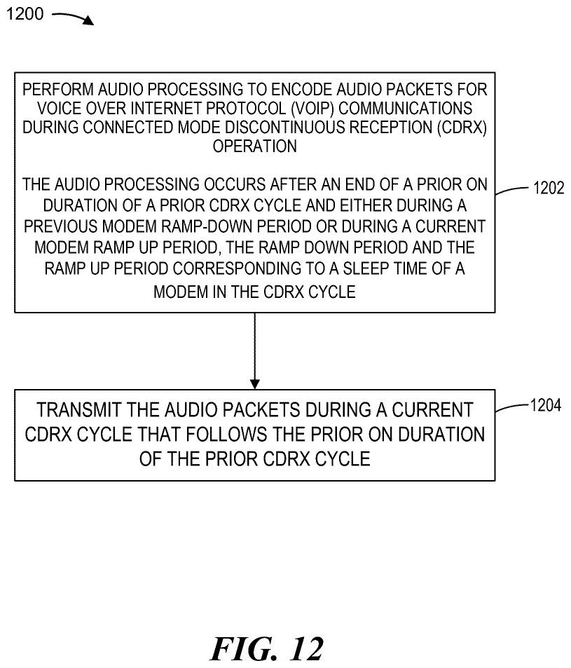

FIG. 12 is a flow diagram illustrating an example process 1200 performed, for example, by a user equipment (UE), in accordance with various aspects of the present disclosure. The example process 1200 is an example of voice over internet protocol (VoIP) audio processing. The operations of the process 1200 may be implemented by a UE 120.

At block 1202, the user equipment (UE) performs audio processing to encode audio packets for voice over internet protocol (VoIP) communications during connected mode discontinuous reception (CDRX) operation. The audio processing occurs after an end of a prior ON duration of a prior CDRX cycle and either during a previous modem ramp-down period or during a current modem ramp up period. The ramp down period and the ramp up period correspond to a sleep time of a modem in the CDRX cycle. For example, the UE (e.g., using the controller/processor 280, memory 282, and/or the like) may perform audio processing. In some aspects, the audio processing occurs during or before the current modem ramp up period in response to a time for completing the audio processing being less than a threshold amount. In other aspects, the audio processing starts in the prior CDRX cycle and completes in the current CDRX cycle. In still further aspects, the audio processing completes after the previous modem ramp-down period or before the current modem ramp up period.

At block 1204, the user equipment (UE) transmits the audio packets during a current CDRX cycle that follows the prior ON duration of the prior CDRX cycle. For example, the UE (e.g., using the antenna 252, DEMOD/MOD 254, TX MIMO processor 266, transmit processor 264, controller/processor 280, memory 282, and/or the like) may transmit the audio packets.

### Example Aspects

Aspect 1: A method of wireless communication, comprising: performing audio processing to encode audio packets for voice over internet protocol (VoIP) communications during connected mode discontinuous reception (CDRX) operation, the audio processing occurring after an end of a prior ON duration of a prior CDRX cycle and either during a previous modem ramp-down period or during a current modem ramp up period, the ramp down period and the ramp up period corresponding to a sleep time of a modem in the CDRX cycle; and transmitting the audio packets during a current CDRX cycle that follows the prior ON duration of the prior CDRX cycle.

Aspect 2: The method of Aspect 1, further comprising programming the modem to wake up for a current ON duration in accordance with a TALK state or a SILENCE state existing at the end of the prior ON duration.

Aspect 3: The method of Aspect 1 or 2, further comprising programming the modem to wake up assuming the TALK state in the current ON duration in response to observing the TALK state at the end of the prior ON duration, such that a modem awakens in accordance with a scheduling request (SR) position.

Aspect 4: The method of Aspect 1, 2, or 3, further comprising programming the modem to wake up assuming the SILENCE state in the current ON duration in response to observing the SILENCE state at the end of the prior ON duration, such that a modem awakens in accordance with the current ON duration of the current CDRX cycle.

Aspect 5: The method of any of the preceding Aspects, further comprising programming the modem to wake up in the current ON duration in response to a transition from the SILENCE state to the TALK state at the end of the previous ramp-down period, such that a modem awakens in response to an interrupt to trigger a scheduling request (SR).

Aspect 6: The method of any of the preceding Aspects, further comprising completing the audio processing after the previous modem ramp-down period or before the current modem ramp up period.

Aspect 7: The method of any of the preceding Aspects, in which the audio processing occurs during or before the current modem ramp up period in response to a time for completing the audio processing being less than a threshold amount.

Aspect 8: The method of any of the preceding Aspects, further comprising starting the audio processing in the prior CDRX cycle and completing the audio processing in the current CDRX cycle.

Aspect 9: An apparatus for wireless communication, comprising: at least one memory; and at least one processor coupled to the at least one memory, the at least one processor configured: to perform audio processing to encode audio packets for voice over internet protocol (VoIP) communications during connected mode discontinuous reception (CDRX) operation, the audio processing occurring after an end of a prior ON duration of a prior CDRX cycle and either during a previous modem ramp-down period or during a current modem ramp up period, the ramp down period and the ramp up period corresponding to a sleep time of a modem in the CDRX cycle; and to transmit the audio packets during a current CDRX cycle that follows the prior ON duration of the prior CDRX cycle.

Aspect 10: The apparatus of Aspect 9, in which the at least one processor is further configured to program the modem to wake up for a current ON duration in accordance with a TALK state or a SILENCE state existing at the end of the prior ON duration.

Aspect 11: The apparatus of Aspect 9 or 10, in which the at least one processor is further configured to program the modem to wake up assuming the TALK state in the current ON duration in response to observing the TALK state at the end of the prior ON duration, such that a modem awakens in accordance with a scheduling request (SR) position.

Aspect 12: The apparatus of Aspect 9, 10, or 11, in which the at least one processor is further configured to program the modem to wake up assuming the SILENCE state in the current ON duration in response to observing the SILENCE state at the end of the prior ON duration, such that a modem awakens in accordance with the current ON duration of the current CDRX cycle.

Aspect 13: The apparatus of any of the Aspects 9-12, in which the at least one processor is further configured to program the modem to wake up in the current ON duration in response to a transition from the SILENCE state to the TALK state at the end of the previous ramp-down period, such that a modem awakens in response to an interrupt to trigger a scheduling request (SR).

Aspect 14: The apparatus any of the Aspects 9-13, in which the at least one processor is further configured to complete the audio processing after the previous modem ramp-down period or before the current modem ramp up period.

Aspect 15: The apparatus of any of the Aspects 9-14, in which the audio processing occurs during or before the current modem ramp up period in response to a time for completing the audio processing being less than a threshold amount.

Aspect 16: The apparatus of any of the Aspects 9-15, in which the at least one processor is further configured to start the audio processing in the prior CDRX cycle and completing the audio processing in the current CDRX cycle.

Aspect 17: A non-transitory computer-readable medium having program code recorded thereon, the program code executed by a processor and comprising: program code to perform audio processing to encode audio packets for voice over internet protocol (VoIP) communications during connected mode discontinuous reception (CDRX) operation, the audio processing occurring after an end of a prior ON duration of a prior CDRX cycle and either during a previous modem ramp-down period or during a current modem ramp up period, the ramp down period and the ramp up period corresponding to a sleep time of a modem in the CDRX cycle; and program code to transmit the audio packets during a current CDRX cycle that follows the prior ON duration of the prior CDRX cycle.

Aspect 18: The non-transitory computer-readable medium of Aspect 17, in which the program code comprises program code to program the modem to wake up for a current ON duration in accordance with a TALK state or a SILENCE state existing at the end of the prior ON duration.

Aspect 19: The non-transitory computer-readable medium of Aspect 17 or 18, in which the program code comprises program code to program the modem to wake up assuming the TALK state in the current ON duration in response to observing the TALK state at the end of the prior ON duration, such that a modem awakens in accordance with a scheduling request (SR) position.

Aspect 20: The non-transitory computer-readable medium of Aspect 17, 18, or 19, in which the program code comprises program code to program the modem to wake up assuming the SILENCE state in the current ON duration in response to observing the SILENCE state at the end of the prior ON duration, such that a modem awakens in accordance with the current ON duration of the current CDRX cycle.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication, comprising:
performing audio processing to encode audio packets for voice over internet protocol (VoIP) communications during connected mode discontinuous reception (CDRX) operation, the audio processing occurring after an end of a prior ON duration of a prior CDRX cycle and either during a previous modem ramp-down period or during a current modem ramp up period, the ramp down period and the ramp up period corresponding to a sleep time of a modem in the CDRX cycle; and
transmitting the audio packets during a current CDRX cycle that follows the prior ON duration of the prior CDRX cycle.

2. The method of claim 1, further comprising programming the modem to wake up for a current ON duration in accordance with a TALK state or a SILENCE state existing at the end of the prior ON duration.

3. The method of claim 2, further comprising programming the modem to wake up assuming the TALK state in the current ON duration in response to observing the TALK state at the end of the prior ON duration, such that a modem awakens in accordance with a scheduling request (SR) position.

4. The method of claim 2, further comprising programming the modem to wake up assuming the SILENCE state in the current ON duration in response to observing the SILENCE state at the end of the prior ON duration, such that a modem awakens in accordance with the current ON duration of the current CDRX cycle.

5. The method of claim 2, further comprising programming the modem to wake up in the current ON duration in response to a transition from the SILENCE state to the TALK state at the end of the previous ramp-down period, such that a modem awakens in response to an interrupt to trigger a scheduling request (SR).

6. The method of claim 1, further comprising completing the audio processing after the previous modem ramp-down period or before the current modem ramp up period.

7. The method of claim 1, in which the audio processing occurs during or before the current modem ramp up period in response to a time for completing the audio processing being less than a threshold amount.

8. The method of claim 1, further comprising starting the audio processing in the prior CDRX cycle and completing the audio processing in the current CDRX cycle.

9. An apparatus for wireless communication, comprising:
at least one memory; and
at least one processor coupled to the at least one memory, the at least one processor configured:
to perform audio processing to encode audio packets for voice over internet protocol (VoIP) communications during connected mode discontinuous reception (CDRX) operation, the audio processing occurring after an end of a prior ON duration of a prior CDRX cycle and either during a previous modem ramp-down period or during a current modem ramp up period, the ramp down period and the ramp up period corresponding to a sleep time of a modem in the CDRX cycle; and
to transmit the audio packets during a current CDRX cycle that follows the prior ON duration of the prior CDRX cycle.

10. The apparatus of claim 9, in which the at least one processor is further configured to program the modem to wake up for a current ON duration in accordance with a TALK state or a SILENCE state existing at the end of the prior ON duration.

11. The apparatus of claim 10, in which the at least one processor is further configured to program the modem to wake up assuming the TALK state in the current ON duration in response to observing the TALK state at the end of the prior ON duration, such that a modem awakens in accordance with a scheduling request (SR) position.

12. The apparatus of claim 10, in which the at least one processor is further configured to program the modem to wake up assuming the SILENCE state in the current ON duration in response to observing the SILENCE state at the end of the prior ON duration, such that a modem awakens in accordance with the current ON duration of the current CDRX cycle.

13. The apparatus of claim 10, in which the at least one processor is further configured to program the modem to wake up in the current ON duration in response to a transition from the SILENCE state to the TALK state at the end of the previous ramp-down period, such that a modem awakens in response to an interrupt to trigger a scheduling request (SR).

14. The apparatus for wireless communication of claim 9, in which the at least one processor is further configured to complete the audio processing after the previous modem ramp-down period or before the current modem ramp up period.

15. The apparatus of claim 9, in which the audio processing occurs during or before the current modem ramp up period in response to a time for completing the audio processing being less than a threshold amount.

16. The apparatus of claim 9, in which the at least one processor is further configured to start the audio processing in the prior CDRX cycle and completing the audio processing in the current CDRX cycle.

17. A non-transitory computer-readable medium having program code recorded thereon, the program code executed by a processor and comprising:
program code to perform audio processing to encode audio packets for voice over internet protocol (VoIP) communications during connected mode discontinuous reception (CDRX) operation, the audio processing occurring after an end of a prior ON duration of a prior CDRX cycle and either during a previous modem ramp-down period or during a current modem ramp up period, the ramp down period and the ramp up period corresponding to a sleep time of a modem in the CDRX cycle; and
program code to transmit the audio packets during a current CDRX cycle that follows the prior ON duration of the prior CDRX cycle.

18. The non-transitory computer-readable medium of claim 17, in which the program code comprises program code to program the modem to wake up for a current ON duration in accordance with a TALK state or a SILENCE state existing at the end of the prior ON duration.

19. The non-transitory computer-readable medium of claim 18, in which the program code comprises program code to program the modem to wake up assuming the TALK state in the current ON duration in response to observing the TALK state at the end of the prior ON duration, such that a modem awakens in accordance with a scheduling request (SR) position.

20. The non-transitory computer-readable medium of claim 18, in which the program code comprises program code to program the modem to wake up assuming the SILENCE state in the current ON duration in response to observing the SILENCE state at the end of the prior ON duration, such that a modem awakens in accordance with the current ON duration of the current CDRX cycle.
